(19) United States
(12) Patent Application Publication
(10) Pub. No.: US 2026/0189069 A1
(43) Pub. Date: Jul. 2, 2026

(54) HYBRID COIL FOR WIRELESS POWER TRANSFER

(71) Applicant: Renesas Electronics America Inc., Milpitas, CA (US)

(72) Inventors: Shangfeng JIANG, Chengdu, Sichuan (CN); Sheng YUAN, Putuo District, Shanghai (CN); Weiwei ZHOU, Chengdu, Sichuan (CN); Jiangjian HUANG, Milpitas, CA (US); Bo TANG, Chengdu, Sichuan (CN); Hulong ZENG, San Jose, CA (US)

(73) Assignee: Renesas Electronics America Inc., Milpitas, CA (US)

(21) Appl. No.: 18/837,394

(22) PCT Filed: Mar. 30, 2023
(86) PCT No.: PCT/CN2023/084995

§ 371 Date: Aug. 9, 2024

(51) Int. Cl. H02J 50/10; H01F 27/28; H01F 41/04; H01F 41/061; H02J 50/00

(52) U.S. Cl. CPC H02J 50/10; H01F 27/2804; H01F 27/2823; H01F 27/2871; H01F 41/041; H01F 41/061; H02J 50/005; H01F 2027/2809

(57) ABSTRACT

A wireless power apparatus may include a receiver coil with a first conductor assembly having a first conductor type, the receiver coil with a second conductor assembly having a second conductor type that may be different from the first conductor type, the first conductor assembly and the second conductor assembly may be connected in series to form a hybrid coil.

### BACKGROUND

The present disclosure relates in general to systems, apparatuses and methods including wireless power transfer using a hybrid coil configuration.

Wireless power transfer (WPT) systems may include a power transmitter having a transmitter coil and a power receiver having a receiver coil. The transmitter coil and the receiver coil may be brought close to one another to form a transformer that may facilitate inductive transmission of alternating current (AC) power. The transfer of AC power, from the transmitter to the receiver, may facilitate powering a device containing the receiver coil, or charging of a battery within the device. Charging power may be increased to reduce charging time. However, increased charging power may result in increased heat generation on the receiver side which may reduce the overall charging time. Some receiver coils use multi-stranded wire where each strand may see a different magnetic flux which can lead to opposing eddy currents that may also generate additional heat. Finally, as the frequency increases for power applied to a coil, current tends to flow closer to the surface of the conductors in the coil according to the skin depth effect which may reduce the effective cross-section of the conductor thereby increasing effective resistance which may further generate additional heat. A solution is needed to address these issues and others.

### SUMMARY

In one embodiment, a wireless power system is generally described. The wireless power system may include an alternating current power source configured to provide electrical power; a power transmitter having a transmitter coil being wound circularly around a center point and disposed in a first plane to form a planar transmitter coil, the planar transmitter coil may be configured to be connected to the alternating current power source to wirelessly transmit power, a power receiver with a receiver coil may have a first conductor assembly with a first conductor type, the receiver coil may have a second conductor assembly with a second conductor type that may be different from the first conductor type, the first conductor assembly and the second conductor assembly may be connected in series to form a hybrid coil, the first conductor assembly may be an inner winding and the second conductor assembly may be an outer winding, the inner winding may be wound circularly around a center point in a second plane, the outer winding may be wound around the inner winding in the second plane to form a planar hybrid receiver coil, the power receiver may be configured to receive power from the planar transmitter coil when the planar hybrid receiver coil may be in proximity to the planar transmitter coil; and a load may be configured to receive power from the power receiver.

In this embodiment, the wireless power system, wherein the inner winding may include a single conductor having a single conducting path that may cross a radial dimension of the receiver coil once for each rotation of the inner winding around the center point in the second plane, and wherein the outer winding may include a plurality of radially adjacent conductors, each of the radially adjacent conductors may have a radially adjacent conducting path that may cross the radial dimension of the receiver coil once for each rotation of the outer winding around the inner winding and around the center point in the second plane.

In this embodiment, the wireless power system, wherein the inner winding conductor type may include one of a first flat wire layer disposed in the second plane, a multi-layer flat wire layer having a first flat wire layer in the second plane and a second flat wire layer in a third plane that may be parallel to the second plane, a single flexible printed circuit wire layer disposed in the second plane, and a multi-layer flexible printed circuit wire layer having a first layer in the second plane and a second layer in the third plane that may be parallel to the second plane, and wherein each of the plurality of radially adjacent conductors may include one of a multi-strand wire and a flexible printed circuit wire.

In this embodiment, the wireless power system, wherein the inner winding may have a first winding width in a radial dimension in the second plane and the outer winding may have a second winding width in the radial dimension in the second plane, wherein the first winding width may be substantially equal to the second winding width.

In this embodiment, the wireless power system may further include a first layer connector configured to connect a first receiver coil lead to a first end of the inner winding, the first layer connector may have a first layer connector width in the radial dimension in the second plane that may be substantially equal to the first winding width; a second layer connector may be configured to connect a second end of the inner winding to a first end of the outer winding, the second layer connector may have a second layer connector width in the radial dimension in the second plane that may be substantially equal to the first winding width; and a third layer connector may be configured to connect to a second end of the outer winding to a second receiver coil lead, the third layer connector may have a third layer connector width in the radial dimension in the second plane that may be substantially equal to the second winding width.

In one embodiment, a wireless power apparatus is generally described. The wireless power apparatus may include a receiver coil with a first conductor assembly having a first conductor type, the receiver coil with a second conductor assembly having a second conductor type that may be different from the first conductor type, the first conductor assembly and the second conductor assembly may be connected in series to form a hybrid coil. In this embodiment, the wireless power apparatus, wherein the first conductor assembly may be an inner winding being wound circularly around a center point in a plane and the second conductor assembly may be an outer winding being wound around the inner winding in the plane to form a planar hybrid receiver coil. In this embodiment, the wireless power apparatus, wherein the inner winding may include a single conductor may have a single conducting path that may cross a radial dimension of the planar hybrid receiver coil once for each rotation of the inner winding around the center point in the plane.

In this embodiment, the wireless power apparatus, wherein the plane may be a first plane, and wherein the inner winding conductor type may include one of: a single flat wire type, wherein the inner winding includes a single flat wire layer with a first conductor in the first plane; a multi-layer flat wire type, wherein the inner winding may include a first flat wire layer with a first conductor in the first plane and a second flat wire layer with a second conductor in a second plane that may be parallel to the first plane; a single flexible printed circuit wire type, wherein the inner winding may include a single flexible printed circuit wire layer with a first conductor in the first plane; and a multi-layer flexible printed circuit wire type, wherein the inner winding may include a first flexible printed circuit wire layer with a first conductor in the first plane and a second flexible printed circuit wire layer with a second conductor in a second plane that may be parallel to the first plane.

In this embodiment, the wireless power apparatus, wherein when the inner winding conductor type may be one of the multi-layer flat wire type and the multi-layer flexible printed circuit wire type, the wireless power apparatus may further include a first vertical connector and may be configured to connect a first end of the first conductor in the first plane with a first end of the second conductor in the second plane, the first vertical connector may be configured to connect with a first layer connector, the first layer connector may be configured to connect with a first receiver coil lead; and a second vertical connector may be configured to connect a second end of the first conductor in the first plane with a second end of the second conductor in the second plane, the second vertical connector may be configured to connect with a second layer connector, the second layer connector may be configured to connect with a second receiver coil lead.

In this embodiment, the wireless power apparatus, wherein the outer winding may include a plurality of radially adjacent conductors, each of the radially adjacent conductors may have a radially adjacent conducting path that may cross a radial dimension of the planar hybrid receiver coil once for each rotation of the outer winding around the center point in the plane. In this embodiment, the wireless power apparatus, wherein each of the plurality of radially adjacent conductors may include one of a multi-strand wire and a flexible printed circuit wire.

In this embodiment, the wireless power apparatus, wherein the inner winding may have a first winding width in a radial dimension in the plane and the outer winding may have a second winding width in the radial dimension in the plane, wherein the first winding width may be substantially equal to the second winding width.

In this embodiment, the wireless power apparatus may further include a first layer connector configured to connect a first receiver coil lead to a first end of the inner winding, the first layer connector may have a first layer connector width in the radial dimension in the plane, the first layer connector width may be substantially equal to the first winding width; a second layer connector may be configured to connect a second end of the inner winding to a first end of the outer winding, the second layer connector may have a second layer connector width in the radial dimension in the plane, the second layer connector width may be substantially equal to the first winding width; and a third layer connector may be configured to connect a second end of the outer winding to a second receiver coil lead, the third layer connector may have a third layer connector width in the radial dimension in the plane, the second layer connector width may be substantially equal to the first winding width. In this embodiment, the wireless power apparatus may further include a power receiver coupled to the hybrid coil and configured to receive power from a transmitter coil coupled to a power transmitter when the hybrid coil may be in proximity to the transmitter coil; and a load may be configured to receive power from the power receiver.

In one embodiment, a method for constructing a wireless power apparatus is generally described. The method may include forming a first conductor assembly having a first conductor type; forming a second conductor assembly having a second conductor type that may be different from the first conductor type; and connecting the first conductor assembly and the second conductor assembly in series to form a receiver coil as a hybrid coil. In this embodiment, the method for constructing a wireless power apparatus may further include, winding the first conductor assembly circularly around a center point in a plane as an inner winding; and winding second conductor assembly circularly around the first conductor assembly in the plane as an outer winding to form a planar hybrid receiver coil.

In this embodiment, the method for constructing a wireless power apparatus, wherein the plane may be a first plane, and wherein the inner winding conductor type may include one of: a single flat wire type, wherein the inner winding includes a single flat wire layer with a first conductor in the first plane; a multi-layer flat wire type, wherein the inner winding includes a first flat wire layer with a first conductor in the first plane and a second flat wire layer with a second conductor in a second plane that may be parallel to the first plane; a single flexible printed circuit wire type, wherein the inner winding includes a single flexible printed circuit wire layer with a first conductor in the first plane; and a multi-layer flexible printed circuit wire type, wherein the inner winding may include a first flexible printed circuit wire layer with a first conductor in the first plane and a second flexible printed circuit wire layer with a second conductor in a second plane that may be parallel to the first plane.

In this embodiment, the method for constructing a wireless power apparatus, wherein when the inner winding conductor type may be one of the multi-layer flat wire type and the multi-layer flexible printed circuit wire type, the method may further include connecting with a first vertical connector a first end of the first conductor in the first plane with a first end of the second conductor in the second plane, the first vertical connector may be configured to connect with a first layer connector, the first layer connector may be configured to connect with a first receiver coil lead; and connecting a second vertical connector may be configured to connect a second end of the first conductor in the first plane with a first end of the second conductor in the second plane, the second vertical connector may be configured to connect with a second layer connector, the second layer connector may be configured to connect with a second receiver coil lead.

In this embodiment, the method for constructing a wireless power apparatus, wherein the inner winding may have a first conductor with a single conducting path that crosses a radial dimension of the planar hybrid receiver coil once for each rotation of the inner winding around the center point in the first plane, wherein when the inner winding conductor type may be one of the multi-layer flat wire type and the multi-layer flexible printed circuit type, the second conductor may have a second conducting path that may cross a radial dimension of the planar hybrid receiver coil once for each rotation of the inner winding around the center point in the first plane, and wherein the outer winding may include a plurality of radially adjacent conductors in the first plane, each of the radially adjacent conductors having a radially adjacent conducting path that crosses the radial dimension of the planar hybrid receiver coil once for each rotation of the outer winding.

Further features as well as the structure and operation of various embodiments are described in detail below with reference to the accompanying drawings. In the drawings, like reference numbers may indicate identical or functionally similar elements.

### BRIEF DESCRIPTION OF THE DRAWINGS

FIG. 1 is a block diagram of an example wireless power system according to an embodiment.

FIG. 2 is a diagram showing components of an example power transmitter according to an embodiment.

FIG. 3A is a diagram showing a perspective view of components of an example receiver coil in a hybrid coil configuration according to an embodiment.

FIG. 3B is a diagram showing a close up of a portion of the hybrid coil of FIG. 3A.

FIG. 3C is a diagram showing a top plan view of the hybrid coil of FIG. 3A.

FIG. 4A is a diagram showing an end view of a single flat wire type inner winding according to an embodiment.

FIG. 4B is a diagram showing an end view of a multi-layer flat wire type inner winding according to an embodiment.

FIG. 4C is a diagram showing an end view of a single flexible printed circuit wire type inner winding according to an embodiment.

FIG. 4D is a diagram showing an end view of a multi-layer flexible printed circuit wire type inner winding according to an embodiment.

FIG. 5A is a diagram showing a side view of a multi-layer flat wire type inner winding according to an embodiment.

FIG. 5B is a diagram showing a side view of a multi-layer flexible printed circuit type inner winding according to an embodiment.

FIG. 6 is a diagram showing a side view of a planar transmitter coil in an energized state adjacent to a planar hybrid receiver coil according to an embodiment.

FIGS. 7A-7C illustrate a flow diagram of a method of constructing a wireless power apparatus according to an embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

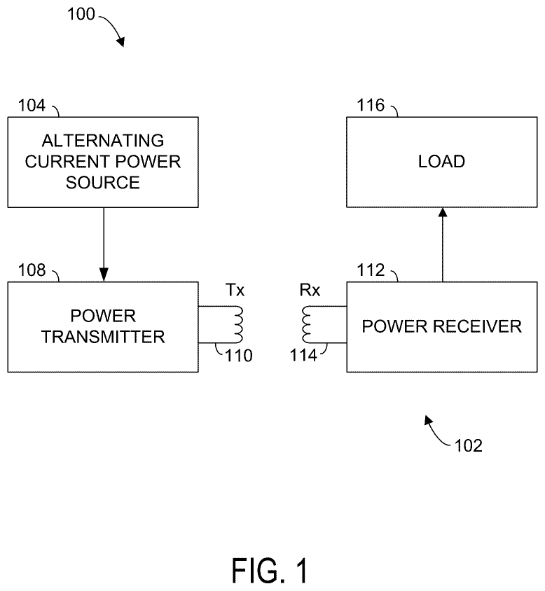

FIG. 1 is a block diagram of an example wireless power system 100 according to an embodiment. System 100 may include an alternating current (AC) power source 104 and a power transmitter 108 having a transmitter conductor 110, hereinafter a transmitter coil 110, configured to transmit power received from alternating current power source 104. System 100 may include a power receiver 112 having a receiver conductor 114, hereinafter a receiver coil 114, configured to receive power transmitted from transmitter coil 110. Finally, system 100 may be connected to a load 116 such as a power consuming device including a cellular telephone, smart watch, smart phone, a music playing device, or the like. Load 116 may also include a power storing device such as a battery along with various electronic components to facilitate the reception, regulation, consumption, and storage of power in load 116. A wireless power apparatus 102 may include power receiver 112, receiver coil 114, and a load 116 which may be connected to receiver coil 114 and configured to receive power from planar transmitter coil 210 when receiver coil 114 may be in proximity to planar transmitter coil 210. In this manner, power from alternating current power source 104 may be transferred to load 116 via inductive coupling between transmitter coil 110 and receiver coil 114 which form a transformer so that wireless power transfer (WPT) may be accomplished using a near field power transfer technique.

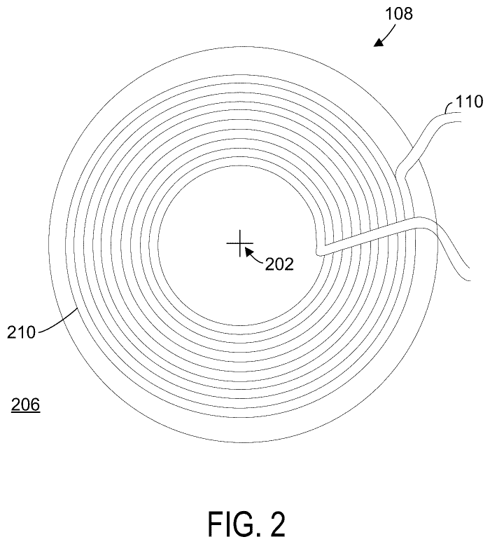

FIG. 2 is a diagram showing an example power transmitter 108 according to an embodiment. Power transmitter 108 may include a transmitter coil 110 configured to conduct and radiate electrical energy. Transmitter coil 110 may be wound circularly at a distance around a center point 202 and disposed in a plane 206 to form a planar transmitter coil 210 configured to be connected to alternating current power source 104. In this manner, planar transmitter coil 210 includes a ring-shaped transmitting region surrounding center point 202.

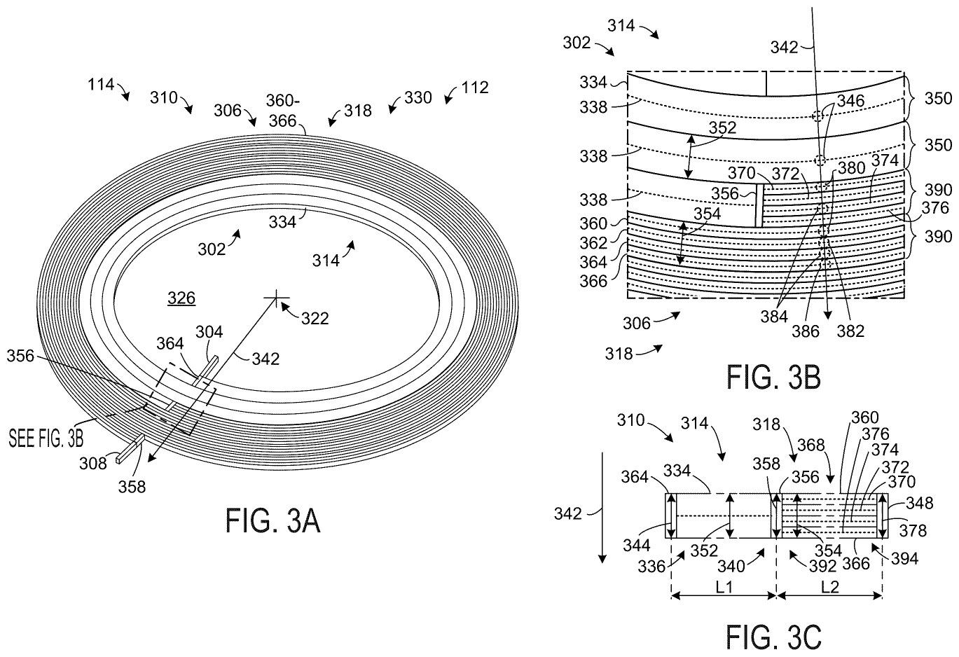

FIG. 3A is a diagram showing a perspective view of components of an example receiver coil in a hybrid coil configuration according to an embodiment. FIG. 3B is a diagram showing a close up of a portion of the hybrid coil of FIG. 3A. FIG. 3C is a diagram showing a top plan view of the hybrid coil of FIG. 3A. In reference to FIG. 1 to FIG. 3C, a wireless power apparatus 102 may include a receiver coil 114 with a first conductor assembly 302 having a first conductor type. Receiver coil 114 may include a second conductor assembly 306 having a second conductor type that may be different from the first conductor type. First conductor assembly 302 and second conductor assembly 306 may be connected in series to form a hybrid coil 310. In this manner, a hybrid coil 310 is composed of two different kinds of coils having different coil properties, including at least one of a width difference, material composition difference, height difference, a difference in the number of conductors, etc.

First conductor assembly 302 may be an inner winding 314 that is wound circularly around a center point 322 in a plane 326, and second conductor assembly 306 may be an outer winding 318 that is wound around inner winding 314 in plane 326 to form a planar hybrid receiver coil 330. Inner winding 314 may include a single conductor 334 (e.g., a single strand) having a single conducting path 338 that crosses a radial dimension 342 of planar hybrid receiver coil 330 once 346 for each rotation 350 of inner winding 314 around center point 322 in plane 326.

Outer winding 318 may include a plurality 368 of radially adjacent conductors 360-366. Each of the plurality of radially adjacent conductors has a radially adjacent conducting path 370-376 that crosses a radial dimension 342 of the planar hybrid receiver coil once 380-386 for each rotation 390 of the outer winding around center point 322 in plane 326. Each of the plurality of radially adjacent conductors 360-366 may include a multi-strand wire or a flexible printed circuit wire. Ordinarily, multi-strand conductors may reduce conductor skin depth effect, while un-equal lengths of multi-strand conductors may cause loop currents. In one example, a flexible printed circuit (FPC) may be one or more conducting paths that are printed or deposited on a substrate such as a copper trace with a dielectric layer such as polyimide, or the FPC may be bonded to an insulating substrate using an adhesive. A FPC may be covered or sandwiched with a protective layer thereby forming an insulated conducting path similar to a wire. Advantageously, FPC may be formed in arbitrary shapes, including coils, so that one or more coil layers may be formed as an FPC, in accordance with various embodiments disclosed herein.

Inner winding 314 may have a first winding width 352 in radial dimension 342 in plane 326 and outer winding 318 may have a second winding width 354 in radial dimension in plane 326. In one example, first winding width 352 is substantially equal to second winding width 354 so that inner winding 314 and outer winding 318 may be uniformly spaced for each rotation. Inner winding 314 may have a length L1 corresponding to the length of inner winding 314 when unrolled. Similarly, outer winding 318 may have a length L2 corresponding to the length of outer winding 318 when unrolled.

Wireless power apparatus 102 may also include a first layer connector 364 configured to connect a first receiver coil lead 304 to a first end 336 of inner winding 314. First layer connector may have a first layer connector width 344 in radial dimension 342 in plane 326. First layer connector width 344 may be substantially equal to first winding width 352. As used herein, substantially equal width includes agreement in width to match the width of the connecting members and avoid irregularities or gaps in spacing that may be caused by a mismatch in width. A second layer connector 356 may be configured to connect a second end 340 of inner winding 314 to a first end 392 of outer winding 318. Second layer connector 356 may have a second layer connector width 358 in the radial dimension in the plane, the second layer connector width being substantially equal to first winding width 352. A third layer connector 348 may be configured to connect a second end 394 of outer winding 318 to a second receiver coil lead 308. Third layer connector 348 may have a third layer connector width 378 in radial dimension 342 in plane 326. Second layer connector width 358 may be substantially equal to first winding width 352. Wireless power apparatus 102 may further include power receiver 112 coupled to hybrid coil 310 and configured to receive power from transmitter coil 110 coupled to power transmitter 108 when hybrid coil 310 is in proximity to transmitter coil 110. Wireless power apparatus 102 may also include a load 116 configured to receive power from power receiver 112.

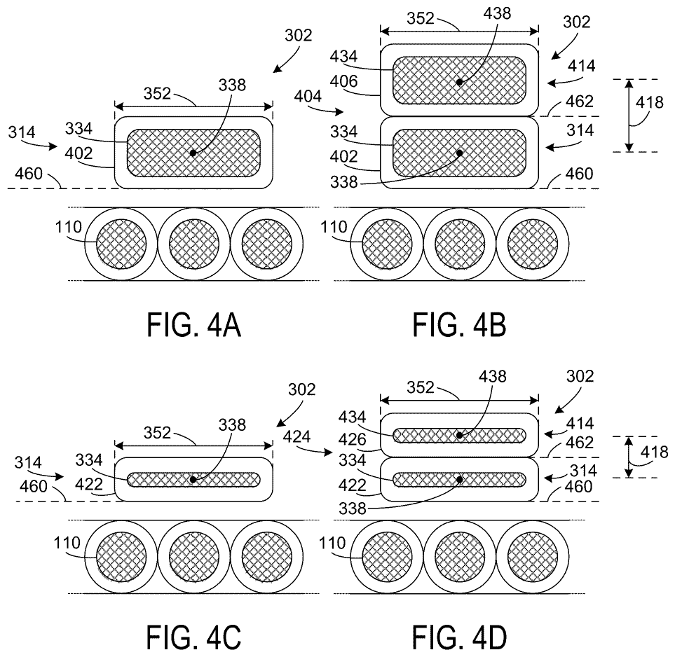

FIG. 4A is a diagram showing an end view of a single flat wire type inner winding according to an embodiment. FIG. 4B is a diagram showing an end view of a multi-layer flat wire type inner winding according to an embodiment. FIG. 4C is a diagram showing an end view of a single flexible printed circuit wire type inner winding according to an embodiment. FIG. 4D is a diagram showing an end view of a multi-layer flexible printed circuit wire type inner winding according to an embodiment. In reference to FIG. 1 to FIG. 4D, plane 326 may be a first plane 460, the inner winding conductor type may include a single flat wire type, wherein the inner winding includes a first flat wire layer 402 with a first conductor 334 in first plane 460. The inner winding conductor type may also be a multi-layer flat wire type, wherein the inner winding may include a first flat wire layer 402 with a first conductor 334 in first plane 460 corresponding to a first inner winding 314, and a second flat wire layer 406 with a second conductor 434 in a second plane 462 that is parallel to first plane 460 corresponding to a second inner winding 414 effectively laid vertically on top of first inner winding 314 at a vertical distance 418 (e.g., height). Advantageously, inner winding 314 conductor types having a wide and flat profile may reduce consequences of skin depth effect when the frequency of the power from alternating current power source 104 for power applied to planar transmitter coil 210 is increased and, as a consequence, the frequency of the power received by planar hybrid receiver coil 330 is also increased.

The inner winding conductor type may also be a single flexible printed circuit wire type, wherein the inner winding includes a single flexible printed circuit wire layer 422 with a first conductor 334 in first plane 460. Finally, the inner winding conductor type may also be a multi-layer flexible printed circuit wire type, wherein the inner winding includes a first flexible printed circuit wire layer 422 with a first conductor 334 in first plane 460 corresponding to first inner winding 314, and a second flexible printed circuit wire layer 426 with a second conductor 434 in second plane 462 that is parallel to first plane 460 corresponding to a second inner winding 414 effectively laid on top of first inner winding 314 having a vertical distance 418. While first inner winding 314 and second inner winding 414 illustrate two vertically stacked inner windings corresponding to first conductor assembly 302, three or more layers may be used.

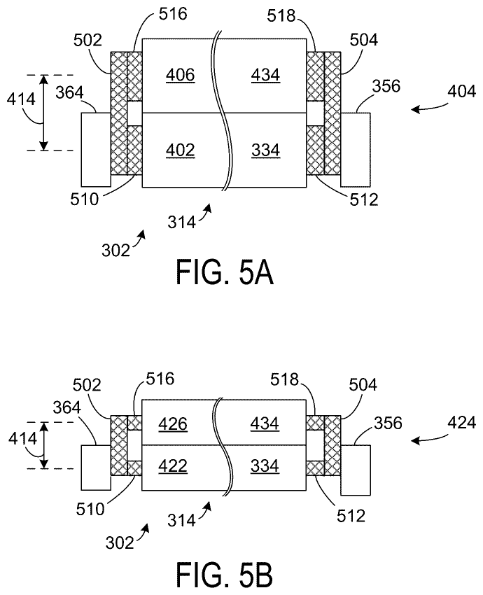

FIG. 5A is a diagram showing a side view of a multi-layer flat wire type inner winding according to an embodiment. FIG. 5B is a diagram showing a side view of a multi-layer flexible printed circuit type inner winding according to an embodiment. In reference to FIG. 1 to FIG. 5B, when the inner winding conductor type is either the multi-layer flat wire type or the multi-layer flexible printed circuit wire type, wireless power apparatus 102 may further include a first vertical connector 502 that may be configured to connect a first end 510 of first conductor 334 in first plane 460 with a first end 516 of second conductor 434 in second plane 462. First vertical connector 502 may be configured to connect with a first layer connector 364 configured to connect with a first receiver coil lead 304. A second vertical connector 504 may be configured to connect a second end 512 of first conductor 334 in first plane 460 (e.g., with reference to planar hybrid receiver coil 330) with a second end 518 of second conductor 434 in second plane 462. Second vertical connector 504 may be configured to connect with a second layer connector 356 and a second receiver coil lead 308. Power received by hybrid coil 310 (e.g., planar hybrid receiver coil 330) may be conducted through first receiver coil lead 304 and second receiver coil lead 308 to power receiver 112.

A wireless power system 100 may include an alternating current power source 104 configured to provide electrical power. Wireless power system 100 may also include a power transmitter 108 having a transmitter coil 110 being wound circularly around a center point 202 and disposed in a first plane 206 to form a planar transmitter coil 210 configured to be connected to alternating current power source 104 to wirelessly transmit power. Wireless power system 100 may include a power receiver 112 with a receiver coil 114 having a first conductor assembly 302 with a first conductor type. Receiver coil 114 may have a second conductor assembly 306 with a second conductor type that is different from the first conductor type. First conductor assembly 302 and second conductor assembly 306 may be connected in series to form a hybrid coil 310.

First conductor assembly 302 may include an inner winding 314, while second conductor assembly 306 may include an outer winding 318. Inner winding 314 may be wound circularly (e.g., wound around in a circular fashion) around a center point 322 in a second plane 460 different from and parallel to first plane 206 associated with planar transmitter coil 210. Similarly, outer winding 318 may be wound around inner winding 314 in second plane 460 to form a planar hybrid receiver coil 330. Power receiver 112 may be configured to receive power from planar transmitter coil 210 when planar hybrid receiver coil 330 is in proximity to planar transmitter coil 210. A load 116 may be connected to power receiver 112 and configured to receive power wirelessly transferred from power transmitter 108.

Inner winding 314 may include a single conductor 334 having a single conducting path 338 that crosses a radial dimension 342 of the planar hybrid receiver coil 330 once 346 for each rotation 350 of inner winding 314 around center point 322 in second plane 460. Single conducting path 338 may be illustrated as flowing centrally within first conductor 334 to show a single crossing point on radial dimension 342, while actual current may flow on a surface of first conductor 334. Outer winding 318 may include a plurality 368 of radially adjacent conductors 360-366. Each of the radially adjacent conductors may have a radially adjacent conducting path 370-376 that crosses radial dimension 342 of planar hybrid receiver coil 330 once 380-386 for each rotation 390 of outer winding 318 around inner winding 314 and around center point 322 in plane 460. While outer winding 318 is illustrated with four adjacent conductors, the number of adjacent conductors may be two or more.

Inner winding 314 may include a first flat wire layer 402 disposed in second plane 460. Inner winding 314 may include a multi-layer flat wire layer 404 having a first flat wire layer 402 in second plane 426 and a second flat wire layer 406 in a third plane 462 (e.g., in reference to planar transmitter coil 210 as first plane 206) that is parallel to the second plane. Inner winding 314 may include a single flexible printed circuit wire layer 422 disposed in the second plane. Finally, inner winding 314 may include a multi-layer flexible printed circuit wire layer 424 having a first layer 422 in second plane 460 and a second layer 426 in third plane 462 that is parallel to the second plane, and wherein each of the plurality of radially adjacent conductors include one of a multi-strand wire and a flexible printed circuit wire. Inner winding 314 may have a first winding width 352 in radial dimension 342 in second plane 460 and outer winding 318 may have a second winding width 354 in radial dimension 342 in second plane 460. First winding width 352 may be substantially equal to second winding width 354. Thus, hybrid coil 310 may include two different types of windings which may be connected in series to form one coil (e.g., one conductor). Inner winding 314 may have a first conductor type including a single flat wire type, a multi-layer flat wire type, a single flexible printed circuit wire type, or a multi-layer flexible printed circuit wire type so that excessive loop currents may be reduced. Outer winding 318 may have multi-strand wires or flexible printed circuit conductors so that skin depth effect and coil alternating current resistance may be reduced.

Wireless power system 100 may further include a first layer connector 364 configured to connect a first receiver coil lead 304 to a first end 336 of inner winding 314. First layer connector 364 may have a first layer connector width 344 in radial dimension 342 in second plane 460 that is substantially equal to first winding width 352. Second layer connector 356 may be configured to connect a second end 340 of inner winding 314 to a first end 392 of outer winding 318. Second layer connector 356 may have a second layer connector width 358 in radial dimension 342 in second plane 460 that is substantially equal to first winding width 352. Third layer connector 348 may be configured to connect to a second end 394 of outer winding 318 to a second receiver coil lead 308. Third layer connector 348 may have a third layer connector width 378 in radial dimension 342 in second plane 460 that is substantially equal to second winding width 354.

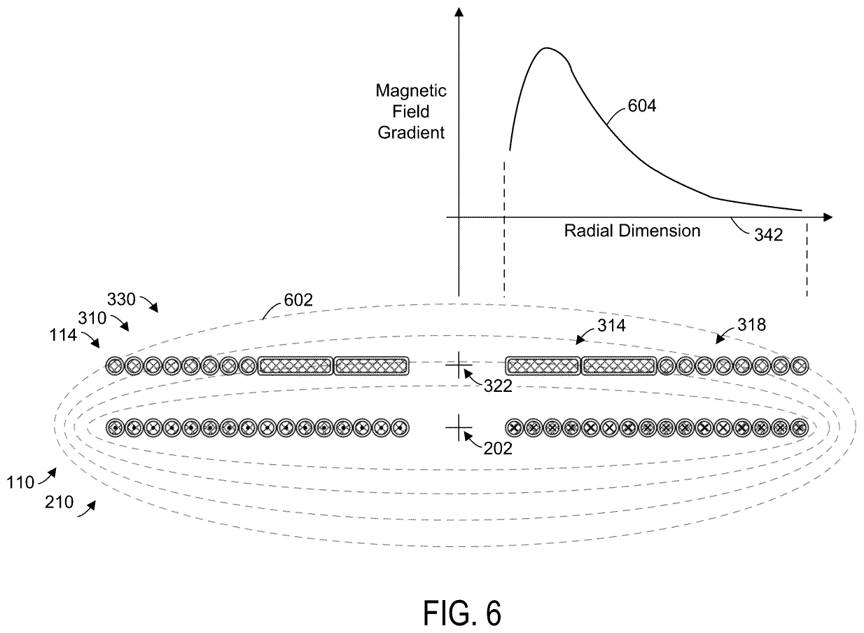

FIG. 6 is a diagram showing a side view of a planar transmitter coil in an energized state adjacent to a planar hybrid receiver coil according to an embodiment. Planar transmitter coil 210 may be energized by an alternating current to create a corresponding magnetic field 602 in order to wirelessly transfer power to an adjacent hybrid coil 310 (e.g., planar hybrid receiver coil 330) in proximity to planar transmitter coil 210. Based on the construction of planar transmitter coil 210 as a disk with a hole in the center, planar transmitter coil 210 may generate a magnetic field 602 having a magnetic field gradient 604 that varies based on radial dimension 342. Magnetic field gradient 604 may be increase in a radial direction toward center point 202 along radial dimension 342 before dropping off near center point 202 in a region near inner winding 314. Magnetic field gradient 604 may decrease in a direction away from center point 202 along radial dimension 342 in a region near outer winding 318. In this manner, the magnetic field generated by planar transmitter coil 210 may not be uniform along radial dimension 342. Hybrid coil 310 advantageously has fewer coils per unit of distance in radial dimension 342 in the region associated with inner winding 314 compared with the more coils per unit of distance in radial dimension 342 in the region associated with outer winding 318. In this manner, magnetic energy captured by both inner winding 314 and outer winding 318 may be more balanced and heat generation may be less in view of the non-uniform nature of the generated magnetic field gradient 604 from planar transmitter coil 210. With brief reference to FIG. 3C, inner winding 314 may have a length L1 corresponding to the length of inner winding 314 when unrolled. Similarly, outer winding 318 has a length L2 corresponding to the length of outer winding 318 when unrolled. A ratio R=L1/L2 depends on the characteristics of the particular components used and the desired balancing of current and heat reduction based on the expected magnetic field gradient 604 for a particular planar transmitter coil 210. Preferably, ratio R may be 1 (e.g., unity) corresponding to when L1=L2, but ratio R may range between 1.2 (e.g., L1=55%, L2=45% of the total length of inner winding 314 and outer winding 318) and 0.8 (e.g., L1=45%, L2=55%)

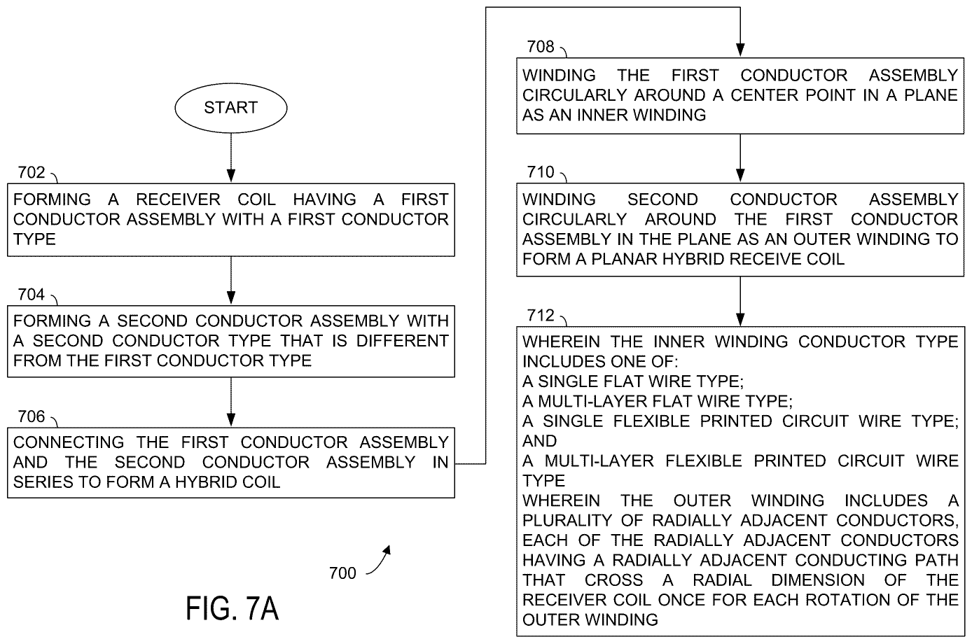

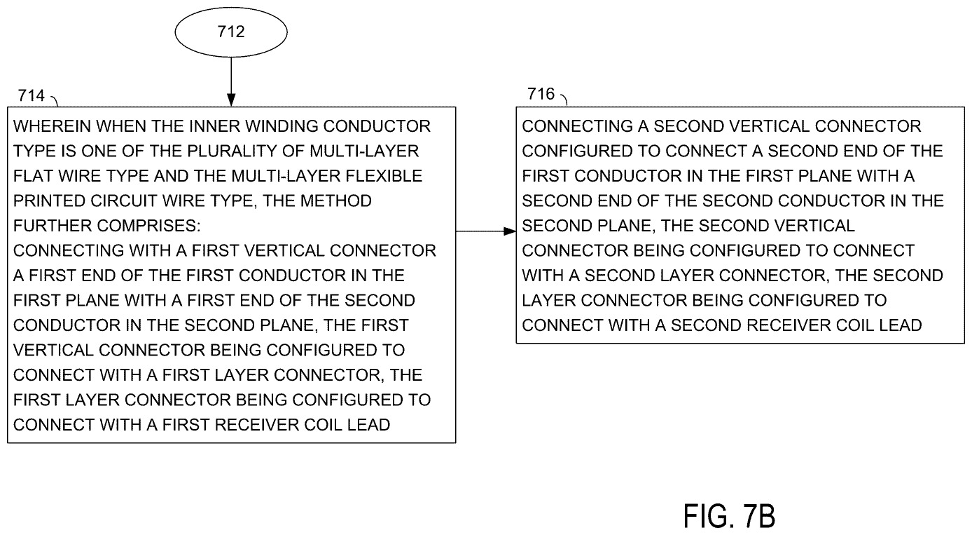

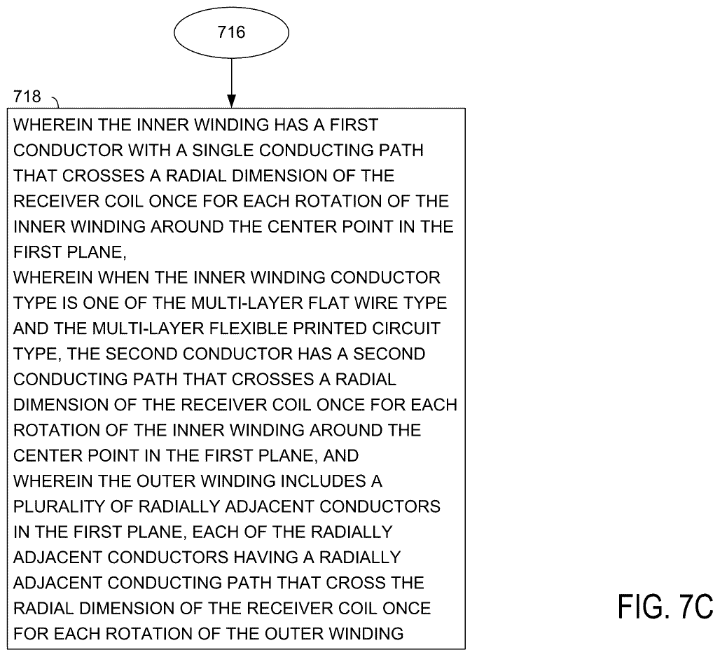

FIGS. 7A-7C illustrate a flow diagram of a method of constructing a wireless power apparatus according to an embodiment. In reference to FIG. 1 to FIG. 7A, a method 700 for constructing a wireless power apparatus 102 may begin in step 702 with forming a first conductor assembly 302 having a first conductor type. Method 700 may continue in step 704 with forming a second conductor assembly 306 having a second conductor type that is different from the first conductor type. Method 700 may continue in step 706 with connecting first conductor assembly 302 and second conductor assembly 306 in series to form a receiver coil 114 as a hybrid coil 310.

Method 700 may continue in step 708 with winding first conductor assembly 302 circularly around a center point 322 in a plane 326 as an inner winding 314. Method 700 may continue in step 710 with winding second conductor assembly 306 circularly around first conductor assembly 302 in plane 326 as an outer winding 318 to form a planar hybrid receiver coil 330.

Method 700 may continue in step 712, where plane 326 may also be designated a first plane 460, and where the inner winding conductor type (e.g., first conductor type) may include a single flat wire type, wherein the inner winding includes a first flat wire layer 402 with a first conductor 434 in first plane 460. Inner winding conductor type may also include a multi-layer flat wire type, wherein the inner winding includes a first flat wire layer 402 with a first conductor 334 in first plane 460 and a second flat wire layer 406 with a second conductor 434 in a second plane 462 that is parallel to the first plane. Inner winding conductor type may also include a single flexible printed circuit wire type, wherein the inner winding includes a single flexible printed circuit wire layer 422 with first conductor 334 in first plane 460. Finally, inner winding conductor type may also include a multi-layer flexible printed circuit wire type, wherein the inner winding includes a first flexible printed circuit wire layer 422 with a first conductor 334 in first plane 460 and a second flexible printed circuit wire layer 426 with a second conductor 434 in a second plane 462 that is parallel to the first plane.

In reference to FIG. 1 to FIG. 7B, method 700 may, when the inner winding conductor type is either the multi-layer flat wire type or the multi-layer flexible printed circuit wire type, continue in step 714 with connecting a first vertical connector 502 with a first end 510 of first conductor 334 in first plane 460 with a first end 516 of second conductor 434 in second plane 462. First vertical connector 502 may be configured to connect with a first layer connector 364 configured to connect with a first receiver coil lead 304. Method 700 may continue in step 716 with connecting a second vertical connector 504 configured to connect a second end 512 of first conductor 334 in first plane 460 with a second end 518 of second conductor 434 in second plane 462. Second vertical connector 504 may be configured to connect with a second layer connector 356 configured to connect with a second receiver coil lead 308.

In reference to FIG. 1 to FIG. 7C, method 700 may conclude in step 718, where inner winding 314 may have a first conductor 334 with a single conducting path 338 that crosses radial dimension 342 of planar hybrid receiver coil 330 once 346 for each rotation 350 of inner winding 314 around center point 322 in first plane 460, wherein when the inner winding conductor type is one of the multi-layer flat wire type and the multi-layer flat wire type, second conductor 434 may have a second conducting path 438 that crosses radial dimension 342 of planar hybrid receiver coil 330 once 346 for each rotation 350 of inner winding 314 around center point 322 in first plane 460, and wherein the outer winding includes a plurality 368 of radially adjacent conductors 360-366 in first plane 460. Each of the radially adjacent conductors may have a radially adjacent conducting path 370-376 that crosses radial dimension 342 of planar hybrid receiver coil 330 once 380-386 for each rotation 390 of outer winding 318 around inner winding 314 and around center point 322. Single conducting path 438 and radially adjacent conducting paths 370-376 may be illustrated as flowing centrally to show a single crossing point on radial dimension 342, while actual current may flow on a surface of the associated conductor.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wireless power apparatus, comprising:
a receiver coil with a first conductor assembly having a first conductor type, the receiver coil with a second conductor assembly having a second conductor type that is different from the first conductor type, the first conductor assembly and the second conductor assembly being connected in series to form a hybrid coil.

2. The wireless power apparatus of claim 1,
wherein the first conductor assembly is an inner winding being wound circularly around a center point in a plane and the second conductor assembly is an outer winding being wound around the inner winding in the plane to form a planar hybrid receiver coil.

3. The wireless power apparatus of claim 2, wherein the inner winding includes a single conductor having a single conducting path that crosses a radial dimension of the planar hybrid receiver coil once for each rotation of the inner winding around the center point in the plane.

4. The wireless power apparatus of claim 3, wherein the plane is a first plane, and wherein the inner winding conductor type includes one of:
a single flat wire type, wherein the inner winding includes a single flat wire layer with a first conductor in the first plane;
a multi-layer flat wire type, wherein the inner winding includes a first flat wire layer with a first conductor in the first plane and a second flat wire layer with a second conductor in a second plane that is parallel to the first plane;
a single flexible printed circuit wire type, wherein the inner winding includes a single flexible printed circuit wire layer with a first conductor in the first plane; and
a multi-layer flexible printed circuit wire type, wherein the inner winding includes a first flexible printed circuit wire layer with a first conductor in the first plane and a second flexible printed circuit wire layer with a second conductor in a second plane that is parallel to the first plane.

5. The wireless power apparatus of claim 4,
wherein when the inner winding conductor type is one of the multi-layer flat wire type and the multi-layer flexible printed circuit wire type, the wireless power apparatus further comprises:
a first vertical connector configured to connect a first end of the first conductor in the first plane with a first end of the second conductor in the second plane, the first vertical connector being configured to connect with a first layer connector, the first layer connector being configured to connect with a first receiver coil lead; and
a second vertical connector configured to connect a second end of the first conductor in the first plane with a second end of the second conductor in the second plane, the second vertical connector being configured to connect with a second layer connector, the second layer connector being configured to connect with a second receiver coil lead.

6. The wireless power apparatus of claim 2,
wherein the outer winding includes a plurality of radially adjacent conductors, each of the radially adjacent conductors having a radially adjacent conducting path that crosses a radial dimension of the planar hybrid receiver coil once for each rotation of the outer winding around the center point in the plane.

7. The wireless power apparatus of claim 6, wherein each of the plurality of radially adjacent conductors includes one of a multi-strand wire and a flexible printed circuit wire.

8. The wireless power apparatus of claim 2, wherein the inner winding has a first winding width in a radial dimension in the plane and the outer winding has a second winding width in the radial dimension in the plane, wherein the first winding width is substantially equal to the second winding width.

9. The wireless power apparatus of claim 8, further comprising:
a first layer connector configured to connect a first receiver coil lead to a first end of the inner winding, the first layer connector having a first layer connector width in the radial dimension in the plane, the first layer connector width being substantially equal to the first winding width;
a second layer connector configured to connect a second end of the inner winding to a first end of the outer winding, the second layer connector having a second layer connector width in the radial dimension in the plane, the second layer connector width being substantially equal to the first winding width; and
a third layer connector configured to connect a second end of the outer winding to a second receiver coil lead, the third layer connector having a third layer connector width in the radial dimension in the plane, the second layer connector width being substantially equal to the first winding width.

10. The wireless power apparatus of claim 1, further comprising:
a power receiver coupled to the hybrid coil and configured to receive power from a transmitter coil coupled to a power transmitter when the hybrid coil is in proximity to the transmitter coil; and
a load configured to receive power from the power receiver.

11. A method for constructing a wireless power apparatus, the method comprising:
forming a first conductor assembly having a first conductor type;
forming a second conductor assembly having a second conductor type that is different from the first conductor type; and
connecting the first conductor assembly and the second conductor assembly in series to form a receiver coil as a hybrid coil.

12. The method of claim 11,
winding the first conductor assembly circularly around a center point in a plane as an inner winding; and
winding second conductor assembly circularly around the first conductor assembly in the plane as an outer winding to form a planar hybrid receiver coil.

13. The method of claim 12,
wherein the plane is a first plane, and wherein the inner winding conductor type includes one of:
a single flat wire type, wherein the inner winding includes a single flat wire layer with a first conductor in the first plane;
a multi-layer flat wire type, wherein the inner winding includes a first flat wire layer with a first conductor in the first plane and a second flat wire layer with a second conductor in a second plane that is parallel to the first plane;
a single flexible printed circuit wire type, wherein the inner winding includes a single flexible printed circuit wire layer with a first conductor in the first plane; and
a multi-layer flexible printed circuit wire type, wherein the inner winding includes a first flexible printed circuit wire layer with a first conductor in the first plane and a second flexible printed circuit wire layer with a second conductor in a second plane that is parallel to the first plane.

14. The method of claim 13,
wherein when the inner winding conductor type is one of the multi-layer flat wire type and the multi-layer flexible printed circuit wire type, the method further comprises:
connecting with a first vertical connector a first end of the first conductor in the first plane with a first end of the second conductor in the second plane, the first vertical connector being configured to connect with a first layer connector, the first layer connector being configured to connect with a first receiver coil lead; and
connecting a second vertical connector configured to connect a second end of the first conductor in the first plane with a first end of the second conductor in the second plane, the second vertical connector being configured to connect with a second layer connector, the second layer connector being configured to connect with a second receiver coil lead.

15. The method of claim 13,
wherein the inner winding has a first conductor with a single conducting path that crosses a radial dimension of the planar hybrid receiver coil once for each rotation of the inner winding around the center point in the first plane,
wherein when the inner winding conductor type is one of the multi-layer flat wire type and the multi-layer flexible printed circuit type, the second conductor has a second conducting path that crosses a radial dimension of the planar hybrid receiver coil once for each rotation of the inner winding around the center point in the first plane, and
wherein the outer winding includes a plurality of radially adjacent conductors in the first plane, each of the radially adjacent conductors having a radially adjacent conducting path that crosses the radial dimension of the planar hybrid receiver coil once for each rotation of the outer winding.

16. A wireless power system, comprising:
an alternating current power source configured to provide electrical power;
a power transmitter having a transmitter coil being wound circularly around a center point and disposed in a first plane to form a planar transmitter coil, the planar transmitter coil configured to be connected to the alternating current power source to wirelessly transmit power;
a power receiver with a receiver coil having a first conductor assembly with a first conductor type, the receiver coil having a second conductor assembly with a second conductor type that is different from the first conductor type, the first conductor assembly and the second conductor assembly being connected in series to form a hybrid coil, the first conductor assembly being an inner winding and the second conductor assembly being an outer winding, the inner winding being wound circularly around a center point in a second plane, the outer winding being wound around the inner winding in the second plane to form a planar hybrid receiver coil, the power receiver configured to receive power from the planar transmitter coil when the planar hybrid receiver coil is in proximity to the planar transmitter coil; and
a load configured to receive power from the power receiver.

17. The system of claim 16,
wherein the inner winding includes a single conductor having a single conducting path that crosses a radial dimension of the receiver coil once for each rotation of the inner winding around the center point in the second plane, and
wherein the outer winding includes a plurality of radially adjacent conductors, each of the radially adjacent conductors having a radially adjacent conducting path that crosses the radial dimension of the receiver coil once for each rotation of the outer winding around the inner winding and around the center point in the second plane.

18. The system of claim 17,
wherein the inner winding conductor type includes one of a first flat wire layer disposed in the second plane, a multi-layer flat wire layer having a first flat wire layer in the second plane and a second flat wire layer in a third plane that is parallel to the second plane, a single flexible printed circuit wire layer disposed in the second plane, and a multi-layer flexible printed circuit wire layer having a first layer in the second plane and a second layer in the third plane that is parallel to the second plane, and
wherein each of the plurality of radially adjacent conductors include one of a multi-strand wire and a flexible printed circuit wire.

19. The system of claim 16, wherein the inner winding has a first winding width in a radial dimension in the second plane and the outer winding has a second winding width in the radial dimension in the second plane, wherein the first winding width is substantially equal to the second winding width.

20. The system of claim 19, further comprising:
a first layer connector configured to connect a first receiver coil lead to a first end of the inner winding, the first layer connector having a first layer connector width in the radial dimension in the second plane that is substantially equal to the first winding width;
a second layer connector configured to connect a second end of the inner winding to a first end of the outer winding, the second layer connector having a second layer connector width in the radial dimension in the second plane that is substantially equal to the first winding width; and
a third layer connector configured to connect to a second end of the outer winding to a second receiver coil lead, the third layer connector having a third layer connector width in the radial dimension in the second plane that is substantially equal to the second winding width.
